(19) United States
(12) Patent Application Publication
(10) Pub. No.: US 2022/0309357 A1
(43) Pub. Date: Sep. 29, 2022

(54) KNOWLEDGE GRAPH (KG) CONSTRUCTION METHOD FOR EVENTUALITY PREDICTION AND EVENTUALITY PREDICTION METHOD

(71) Applicant: GUANGZHOU HKUST FOK YING TUNG RESEARCH INSTITUTE, Guangzhou, Guangdong (CN)

(72) Inventors: Hongming Zhang, Guangzhou, Guangdong (CN); Xin Liu, Guangzhou, Guangdong (CN); Haojie Pan, Guangzhou, Guangdong (CN); Yangqiu Song, Guangzhou, Guangdong (CN)

(21) Appl. No.: 17/613,940

(22) PCT Filed: Sep. 26, 2019
(86) PCT No.: PCT/CN2019/108129

§ 371 Date: Nov. 23, 2021

(30) Foreign Application Priority Data
May 23, 2019 (CN) 201910434546.0

(51) Int. Cl. G06N 5/02; G06F 40/211; G06F 40/30

(52) U.S. Cl. CPC G06N 5/022; G06F 40/211; G06F 40/30

(57) ABSTRACT

Disclosed are a knowledge graph (KG) construction method for eventuality prediction and an eventuality prediction method. The KG construction method preprocesses pre-collected corpora and extracts a plurality of candidate sentences from the corpora; extracts a plurality of eventualities from the candidate sentences based on preset dependency relations; extracts seed relations between the eventualities from the corpora; extracts eventuality relations between the eventualities based on the eventualities and the seed relations between the eventualities, to obtain candidate eventuality relations between the eventualities; and generates a KG for the eventualities based on the eventualities and the candidate eventuality relations between the eventualities, and extracts a common syntactic pattern based on the dependency relation to extract a semantically complete eventuality from the corpora.

### TECHNICAL FIELD

The present disclosure relates to the technical field of natural language processing (NLP), and in particular, to a knowledge graph (KG) construction method for eventuality prediction and an eventuality prediction method.

### BACKGROUND

NLP is an important direction in the field of computer science and artificial intelligence. NLP faces many challenges, including natural language understanding. Therefore, NLP involves area of man-machine interaction. Many challenges involve natural language understanding, which means that a computer is originated from a man-made or natural language input, and natural language generation. Understanding human language requires complex world knowledge. However, a state-of-the-art large-scale KG is only focusing on relations between entities. For example, the KG formalizes words and enumerates categories and relations of words. Typical KGs include WordNet for words, FrameNet for eventualities, and CYc for commonsense knowledge. Existing KGs are only focusing on the relations between entities and are of limited sizes, which restricts the KGs from real-world applications.

### SUMMARY

Based on this, the present disclosure provides a KG construction method for eventuality prediction and an eventuality prediction method, to effectively mine activities, states, eventualities and their relations (ASER), thereby improving quality and effectiveness of a KG.

According to a first aspect, an embodiment of the present disclosure provides a KG construction method for eventuality prediction, including:

preprocessing pre-collected corpora, and extracting a plurality of candidate sentences from the corpora;

extracting a plurality of eventualities from the candidate sentences based on preset dependency relations, so that each eventuality retains complete semantic information of a corresponding candidate sentence;

extracting seed relations between the eventualities from the corpora;

extracting eventuality relations between the eventualities based on the eventualities and the seed relations between the eventualities by a pre-constructed relation bootstrapping network model, to obtain candidate eventuality relations between the eventualities;

generating a KG for the eventualities based on the eventualities and the candidate eventuality relations between the eventualities.

In an embodiment, the extracting a plurality of eventualities from the candidate sentences based on preset dependency relations, so that each eventuality retains complete semantic information of a corresponding candidate sentence specifically includes:

extracting verbs from the candidate sentences;

matching, by the preset dependency relations, an eventuality pattern corresponding to a candidate sentence in which each verb is located; and

extracting, from the candidate sentence and based on the eventuality pattern corresponding to the candidate sentence in which the verb is located, an eventuality centered on the verb.

In an embodiment, the preset dependency relations include a plurality of eventuality patterns, and each pattern includes one or more of connections between nouns, prepositions, adjectives, verbs and edges.

In an embodiment, the preprocessing pre-collected corpora, and extracting a plurality of candidate sentences from the corpora specifically includes:

performing NLP on the corpora, and extracting the plurality of candidate sentences.

In an embodiment, the matching, by the preset dependency relations, an eventuality pattern corresponding to a candidate sentence in which each verb is located specifically includes:

constructing a one-to-one corresponding code for each eventuality pattern in the preset dependency relations; and

performing, based on the code, syntactic analysis on the candidate sentence in which the verb is located, to obtain the eventuality pattern corresponding to the candidate sentence in which the verb is located.

In an embodiment, the extracting seed relations between the eventualities from the corpora specifically includes:

annotating a connective in the corpora by a relation defined in a Penn Discourse Tree Bank (PDTB); and

based on an annotated connective and the eventualities, taking global statistics on annotated corpora, and extracting the seed relationship between the eventualities.

In an embodiment, the extracting eventuality relations between the eventualities based on the eventualities and the seed relations between the eventualities by a pre-constructed relation bootstrapping network model, to obtain candidate eventuality relations between the eventualities specifically includes:

initializing seed relations N and their corresponding two eventualities into an instance X;

training a pre-constructed neural network classifier by the instance X, to obtain the relation bootstrapping network model that automatically marks a relation, and an eventuality relation between the two eventualities; and

taking global statistics on the eventuality relation, adding an eventuality relation with confidence greater than a preset threshold to the instance X, and inputting an obtained instance X into the relation bootstrapping network model again for training to obtain a candidate eventuality relation between the two eventualities.

Compared with the prior art, this embodiment of the present disclosure has the following beneficial effects: A common syntactic pattern is extracted based on the dependency relation through text mining, to extract an eventuality from the corpora, thereby making eventuality extraction simpler and less complex. The syntactic pattern takes a verb of a sentence as a center, so that ASER can be effectively mined, and a high-quality and effective KG can be constructed for eventualities.

According to a second aspect, an embodiment of the present disclosure provides an eventuality prediction method, including:

preprocessing pre-collected corpora, and extracting a plurality of candidate sentences from the corpora;

extracting a plurality of eventualities from the candidate sentences based on preset dependency relations, so that each eventuality retains complete semantic information of a corresponding candidate sentence;

extracting seed relations between the eventualities from the corpora;

extracting eventuality relations between the eventualities based on the eventualities and the seed relations between the eventualities by a pre-constructed relation bootstrapping network model, to obtain candidate eventuality relations between the eventualities;

generating a KG for the eventualities based on the eventualities and the candidate eventuality relations between the eventualities; and

performing eventuality inference on any eventuality by the KG, to obtain relevant eventualities.

In an embodiment, the performing eventuality inference on any eventuality by the KG, to obtain relevant eventualities specifically includes:

performing eventuality retrieval on the eventuality by the KG, to obtain an eventuality corresponding to a maximum eventuality probability as the relevant eventualities.

In an embodiment, the performing eventuality inference on any eventuality by the KG, to obtain relevant eventualities of the eventuality specifically includes:

performing relation retrieval on the eventuality by the KG, to obtain eventualities with eventuality probabilities greater than a preset probability threshold as the relevant eventualities.

Compared with the prior art, this embodiment of the present disclosure has the following beneficial effects: A common syntactic pattern is extracted based on the dependency relation through text mining, to extract an eventuality from the corpora, thereby making eventuality extraction simpler and less complex. The syntactic pattern takes a verb of a sentence as a center, so that ASER can be effectively mined, and a high-quality and effective KG can be constructed for eventualities. The KG can be used to accurately predict a relevant eventuality and generate a better dialogue response, and can be widely used in the field of man-machine dialogues such as problem resolving and a dialogue system.

### BRIEF DESCRIPTION OF THE DRAWINGS

To describe the technical solutions in the present disclosure more clearly, the following briefly describes the accompanying drawings required for describing the implementations. Apparently, the accompanying drawings in the following description show merely some implementations of the present disclosure, and a person of ordinary skill in the art may further derive other drawings from these accompanying drawings without creative efforts.

FIG. 1 is a flowchart of a KG construction method for eventuality prediction according to a first embodiment of the present disclosure;

FIG. 2 is a schematic diagram of an eventuality pattern according to an embodiment of the present disclosure;

FIG. 3 is a schematic diagram of an eventuality extraction algorithm according to an embodiment of the present disclosure;

FIG. 4 is a schematic diagram of a seed pattern according to an embodiment of the present disclosure;

FIG. 5 shows a knowledge extraction framework of ASER according to an embodiment of the present disclosure;

FIG. 6 is a schematic diagram of an eventuality relation type according to an embodiment of the present disclosure; and

FIG. 7 is a flowchart of an eventuality prediction method according to a second embodiment of the present disclosure.

### DETAILED DESCRIPTION

The technical solutions of the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

Common terms are described below before the embodiments of the present disclosure.

State: A state is usually described by a stative verb and cannot be qualified as an action. For example, we cannot say “I am knowing” or “I am loving” because they are actions. A typical state expression is “The coffee machine is ready for brewing coffee.”

Activity: An activity is also referred to as a process. Both the activity and an eventuality are actions described by active verbs. For example, “The coffee machine is brewing coffee” is an activity.

Eventuality: A distinctive feature of the eventuality is that the eventuality is defined as an occurrence that is inherently countable. For details, see Alexander P. D. Mourelatos. 1978. Eventualities, Processes, and States. Compared with the activity using the coffee example, “The coffee machine has brewed coffee twice half hour ago” is used as an eventuality because it admits cardinal count adverbials.

Relation: Relations defined in a PDTB are used, including COMPARISON and CONTINGENCY.

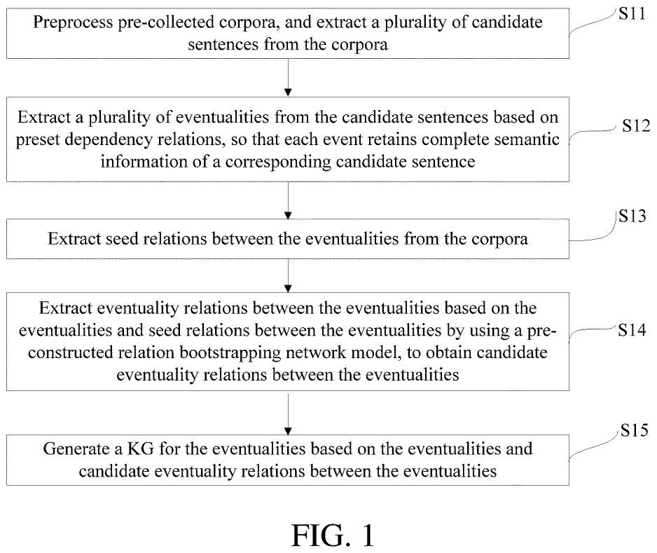

As shown in FIG. 1, a first embodiment of the present disclosure provides a KG construction method for eventuality prediction. The method is executed by a KG construction device for eventuality prediction. The KG construction device for eventuality prediction may be a computing device such as a computer, a mobile phone, a tablet, a laptop or a server. The KG construction method for eventuality prediction may be integrated with the KG construction device for eventuality prediction as one functional module, and executed by the KG construction device for eventuality prediction.

The method specifically includes the following steps.

S11: Preprocess pre-collected corpora, and extract a plurality of candidate sentences from the corpora.

It should be noted that a corpora collection method is not specifically limited in this embodiment of the present disclosure, for example, relevant comments, news articles, and the like may be crawled from an Internet platform, or a corpora set may be directly downloaded from a specific corpus. The corpora include an e-book, a movie subtitle, a news article, a comment, and the like. Specifically, a plurality of comments may be crawled from a social media platform Yelp, a plurality of post records may be crawled from a forum Reddit, a plurality of news articles may be crawled from New York Times, a plurality of pieces of text data may be crawled from Wikipedia, movie subtitles may be obtained from an Opensubtitles2016 corpus, and the like.

S12: Extract a plurality of eventualities from the candidate sentences based on preset dependency relations, so that each eventuality retains complete semantic information of a corresponding candidate sentence.

S13: Extract seed relations between the eventualities from the corpora.

S14: Extract eventuality relations between the eventualities based on the eventualities and the seed relations between the eventualities by a pre-constructed relation bootstrapping network model, to obtain candidate eventuality relations between the eventualities.

S15: Generate a KG for the eventualities based on the eventualities and the candidate eventuality relations between the eventualities.

An eventuality is formed based on the dependency relation. In this way, ASER can be effectively mined, and a high-quality and effective KG (ASER KG) can be constructed. The KG is an eventuality-related hybrid graph. Each eventuality is a hyperedge linking to a set of vertices. Each vertex is a word in a vocabulary. For example, it is defined that v⊆V, where V represents a vertex set, and that E∈ε, where ε represents a hyperedge set, namely, an eventuality set. ε⊆P(V)\{0} represents a subset of a power set of the vertex set V. In addition, it is defined that a relation R_{i,j} between eventualities Eᵢ and Eⱼ satisfies R_{i,j}∈R, where R represents a relation set, and that a relation type T satisfies T∈T, where T represents a relation type set. In this case, a KG H is equal to {V, E, R, T}. The KG H is a hybrid graph combining a hypergraph {V, E} and a traditional graph {E, R}, where a hyperedge of the hypergraph {V, E} is built between vertices, and an edge of the graph {E, R} is built between eventualities. For example, there are two eventualities that each contain three words: E₁=(i, be, hungry) and E₂=(i, eat, anything), and they have a relation R_{1,2}=Result, where Result represents a relation type. In this case, a bipartite graph based on the hypergraph {V, E} can be constructed, where an edge of the bipartite graph is built between a word and an eventuality.

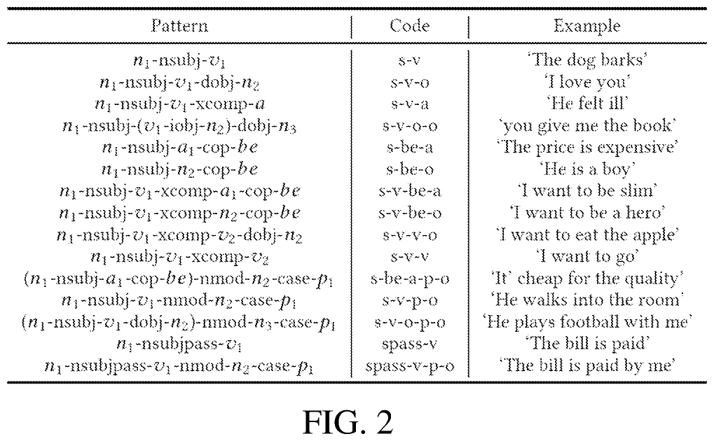

In this embodiment of the present disclosure, words conforming to a specific syntactic pattern are used to represent eventualities, so as to avoid extracting too sparse contents. It is assumed that each eventuality satisfies the following two conditions: (1) An English syntactic pattern is fixed; and (2) a semantic meaning of the eventuality is determined by a word inside the eventuality. Then the eventuality is defined as follows: An eventuality Eᵢ is a hyperedge based on a plurality of words {w_{i,1}, . . . , w_{i,Ni}}, where Nᵢ is the number of words displayed in the eventuality Eᵢ, w_{i,1}, . . . , w_{i,Ni} ∈V, V represents the vocabulary; and a pair of words (w_{i,j}, w_{i,k}) in Eᵢ follows a syntactic relation e_{i,j,k} (in other words, an eventuality pattern given in FIG. 2). w_{i,j} represents different words, while vᵢ represents a unique word in the vocabulary. An eventuality is extracted from an unlabeled large-scale corpus by analyzing a dependency between words. For example, for an eventuality (dog, bark), a relation nsubj is used between the two words to indicate that there is a subject-verb relation between the two words. A fixed eventuality pattern (n₁-nsubj-v₁) is used to extract simple and semantically complete verb phrases to form an eventuality. Because the eventuality pattern is highly precise, accuracy of eventuality extraction can be improved.

In an optional embodiment, the preprocessing pre-collected corpora, and extracting a plurality of candidate sentences from the corpora in S11 specifically includes:

performing NLP on the corpora, and extracting the plurality of candidate sentences.

An NLP process mainly includes word segmentation, data cleaning, labeling, feature extraction, and modeling based on a classification algorithm, a similarity algorithm, or the like. It should be noted that the corpora may be English text or Chinese text. When the corpora are the English text, spell checking, stem extraction, and lemmatization also need to be performed on the corpora.

In an optional embodiment, the extracting a plurality of eventualities from the candidate sentences based on preset dependency relations, so that each eventuality retains complete semantic information of a corresponding candidate sentence in S12 specifically includes the following steps:

S121: Extract verbs from the candidate sentences.

It should be noted that since each candidate sentence may contain a plurality of eventualities, and a verb is a center of each eventuality, in this embodiment of the present disclosure, the Stanford Dependency Parser is used to parse each candidate sentence and extract all verbs in each candidate sentence.

S122: Match, by the preset dependency relations, an eventuality pattern corresponding to a candidate sentence in which each verb is located.

Further, the preset dependency relations include a plurality of eventuality patterns, and each pattern includes one or more of connections between nouns, prepositions, adjectives, verbs and edges.

In an optional embodiment, the matching, by the preset dependency relations, an eventuality pattern corresponding to a candidate sentence in which each verb is located specifically includes:

constructing a one-to-one corresponding code for each eventuality pattern in the preset dependency relations; and

performing, based on the code, syntactic analysis on the candidate sentence in which the verb is located, to obtain the eventuality pattern corresponding to the candidate sentence in which the verb is located.

For the eventuality pattern used in this embodiment of the present disclosure, refer to FIG. 2. In the eventuality pattern shown in FIG. 2, ‘v’ represents a verb other than ‘be’ in a sentence, ‘be’ represents the verb ‘be’ in the sentence, ‘n’ represents a noun, ‘a’ represents an adjective, and ‘p’ represents a preposition. Code represents a unique code of the eventuality pattern. nsubj (nominal subject), xcomp (open clausal complex), iobj (indirect object), dobj (direct object), cop (copula, for example, be, see, and appear, and linking between a proposition subject and a proposition predicate), case, nmod, nsubjpass (passive nominal subject) are edges connecting to words with different parts of speech. The edges are additional elements for extracting an eventuality from a candidate sentence to represent a syntactic dependency relation.

Specifically, the code may be loaded to a syntax analysis tool, for example, the Stanford Dependency Parser, to perform part-of-speech labeling, syntactic analysis, and entity identification on the candidate sentence to obtain the eventuality pattern corresponding to the candidate sentence in which the verb is located. The Stanford Dependency Parser integrates three algorithms: Probabilistic Context-Free Grammar (PCFG), dependency parsing based on a neural network, and transition-based dependency parsing (ShiftReduce). In this embodiment of the present disclosure, optional dependency relations are defined for each eventuality pattern, including but not limited to advmod (adverbial modifier), amod (adaptive modifier), aux (auxiliary, for example, BE, HAVE SHOULD/COULD), neg (negative modifier), and the like. For details, refer to Stanford dependency relations.

S123: Extract, from the candidate sentence and based on the eventuality pattern corresponding to the candidate sentence in which the verb is located, an eventuality centered on the verb.

Further, a negative edge neg is added to each eventuality pattern to further ensure that all extracted eventualities have complete semantic meanings. For example, matching is performed on the candidate sentence and all eventuality patterns in the dependency relation to obtain a dependency relation graph. When the negative dependency edge neg is found in the dependency relation graph, a result extracted based on a corresponding eventuality pattern is determined to be unqualified. Therefore, when the candidate sentence has no object connected, a first eventuality pattern is used for eventuality extraction. Otherwise, a next eventuality pattern is used for eventuality extraction. A sentence “I have a book” is used as an example. <“I”“have”“book”> rather than <“I”“have”> or <“have”“book”> is obtained through eventuality extraction and used as a valid eventuality because <“I”“have”> and <“have”“book”> are not semantically complete.

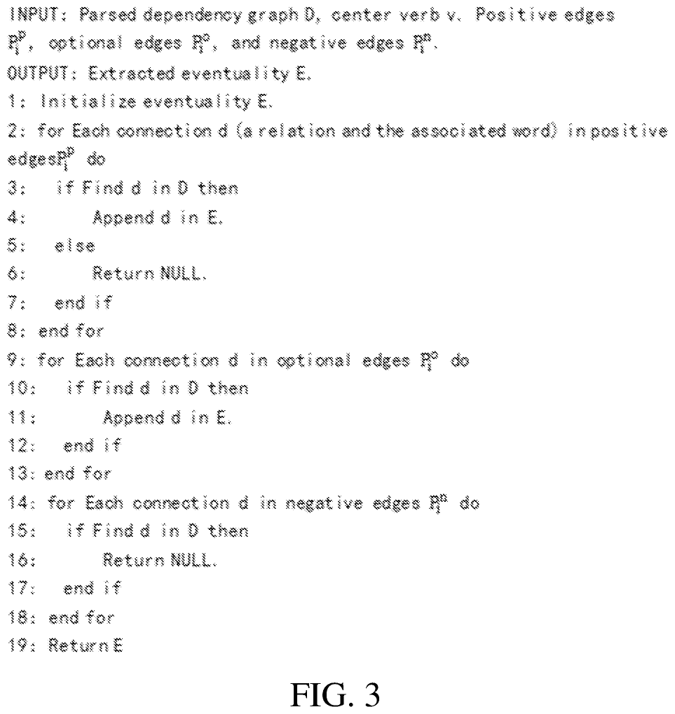

For each possible eventuality pattern Pᵢ and a verb v of a candidate sentence in corpora, whether all positive edges are associated with the verb v is checked. Then, all matched edges and all matched potential edges are added to an extracted eventuality E to obtain a dependency relation graph of the corpora. If any negative edge is found in the dependency relation graph, the extracted eventuality is disqualified and Null is returned. A specific extraction algorithm for extracting an eventuality by an eventuality pattern Pᵢ and the syntax analysis tool is shown in FIG. 3. Time complexity of eventuality extraction is O(|S|·|D|·|V|), where |S| represents the number of sentences, |D| represents the average number of edges in dependency parse trees, and |V| represents the average number of verbs in a sentence. Complexity of eventuality extraction is low.

In an optional embodiment, the extracting seed relations between the eventualities from the corpora in S13 specifically includes:

annotating a connective in the corpora by a relation defined in a PDTB; and

based on an annotated connective and the eventualities, taking global statistics on annotated corpora, and extracting the seed relationship between the eventualities.

In an optional embodiment, the extracting eventuality relations between the eventualities based on the eventualities and the seed relations between the eventualities by a pre-constructed relation bootstrapping network model, to obtain candidate eventuality relations between the eventualities in S14 specifically includes:

initializing seed relations N and their corresponding two eventualities into an instance X;

training a pre-constructed neural network classifier by the instance X, to obtain the relation bootstrapping network model that automatically marks a relation, and an eventuality relation between the two eventualities; and

taking global statistics on the eventuality relation, adding an eventuality relation with confidence greater than a preset threshold to the instance X, and inputting an obtained instance X into the relation bootstrapping network model again for training to obtain the candidate eventuality relation between the two eventualities.

In this embodiment of the present disclosure, after extracting the eventualities from the corpora, relations between the eventualities are extracted by a two-step approach.

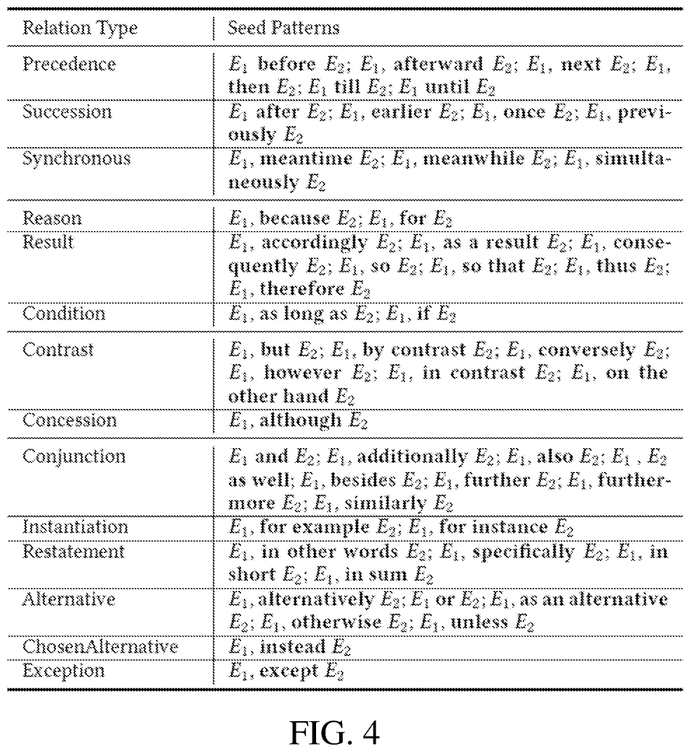

In a first step, the seed relations are extracted from the corpora by explicit connectives defined in the PDTB and using a preset seed pattern. The preset seed pattern is shown in FIG. 4. Some connectives in the PDTB are more ambiguous than other connectives. For example, in PDTB annotation, a connective “while” is annotated as a conjunction for 39 times, a contrast word for 111 times, an expectation word for 79 times, a concession word for 85 times, and the like. When the connective is identified, a relation between two eventualities related to the connective cannot be determined. Some connectives are deterministic. For example, a connective “so that” is annotated for 31 times, and is only associated with a result. In this embodiment of the present disclosure, specific connectives are used. More than 90% annotations of each connective indicate a same relation used as a seed pattern of extracting the seed relations.

It is assumed that one connective and its corresponding relation are c and R respectively. An example <E₁,c,E₂> is given to represent a candidate sentence S, where the two eventualities E₁ and E₂ are connected by the connective c based on dependency parsing. This example is used as an example of the relation R. After the connective is annotated as less ambiguous relations through PDTB annotation, to ensure an example of an extracted seed relation, global statistics is taken on each seed relation R to search for an eventuality relation, the found eventuality relation is used as a seed relation.

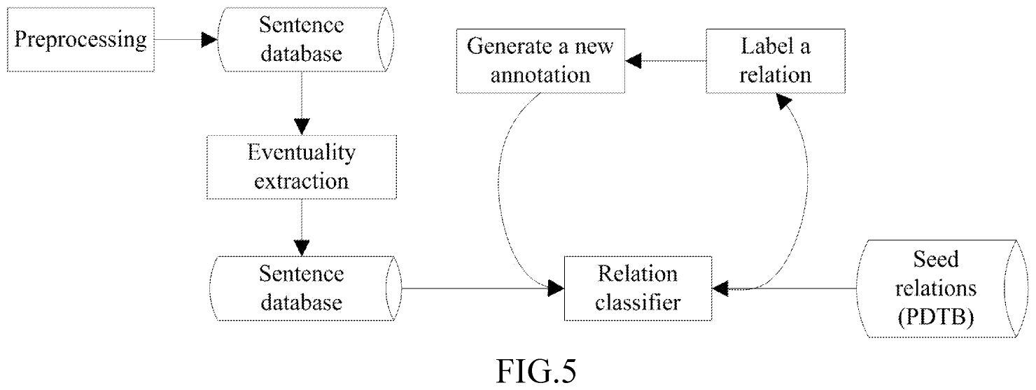

In a second step, a bootstrapping strategy is used to incrementally annotate more eventuality relations to improve coverage of relation search. The bootstrapping strategy is an information extraction technology. For example, the bootstrapping strategy may be executed by Eugene Agichtein and Luis Gravano. 2000. In this embodiment of the present disclosure, an eventuality relation is bootstrapped by a machine learning algorithm based on the neural network. For details, refer to the knowledge extraction framework of the ASER in FIG. 5.

For example, a neural network classifier is constructed. For each extracted instance X, the candidate sentence S and two eventualities E₁ and E₂ extracted in step S12 are used. In the candidate sentence S, a word vector of each word in E₁ and E₂ is mapped into semantic vector space by an algorithm GloVe. A 1-layer bidirectional LSTM network is used to encode a word sequence of an eventuality, and the other 1-layer bidirectional LSTM network is used to encode the word sequence. Sequence information is encoded in the last hidden states h_{E1}, h_{E2} and hₛ. h_{E1}, h_{E2}, h_{E1}-h_{E2}, h_{E1}○h_{E2}, and hₛ are concatenated, and then a concatenated result is fed to a 2-layer feed-forward network with a ReLU activation function. A Softmax function is used to generate a probability distribution for this instance. A cross-entropy loss is put over a training example for each relation. An output prediction of the neural network classifier indicates a probability that a pair of eventualities is classified to each relation. It is assumed that a relation R of a type Tᵢ is Tᵢ, For the instance X=<S, E₁, E₂>, P(Tᵢ|X) is output. In a bootstrapping process, if PP(Tᵢ|X)>τ, the instance is labeled as the relation type Tᵢ, where τ is a preset threshold. In this way, after each step of processing the whole corpus by the neural network classifier, more training examples can be annotated incrementally and automatically for the neural network classifier. Further, an Adam optimizer is used as the classifier. Therefore, complexity is linear with the number of parameters in an LSTM cell L, the average number of automatically annotated instances Nₜ in an iteration, the number of relation types |T|, and the maximum number Iterₘₐₓ of bootstrapping iterations. Therefore, the overall complexity, namely, O(L·Nₜ·|T|·Iterₘₐₓ), is low.

In an optional embodiment, the candidate eventuality relation T includes temporal relations, contingency relations, comparison relations, expansion relations, and co-occurrence relations.

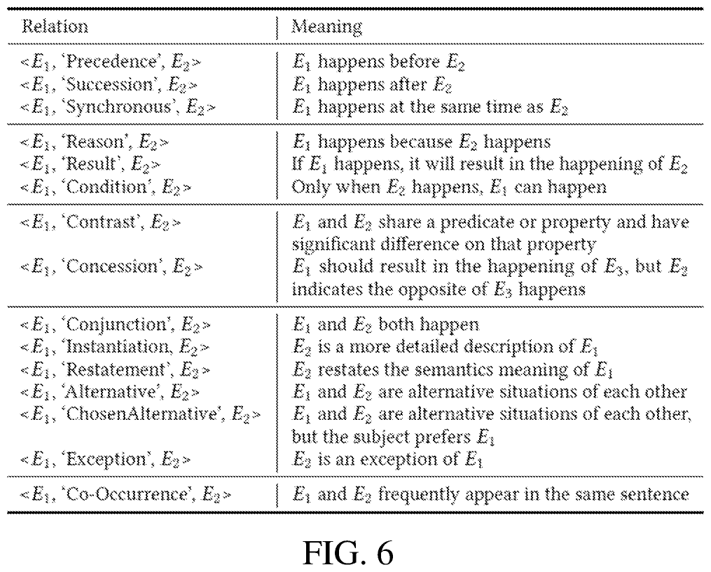

Specifically, the temporal relations include precedence, succession, and synchronous relations. The contingency relations include reason, result, and condition relations. The comparison relations include contrast and concession relations. The expansion relations include conjunction, instantiation, restatement, alternative, chosen alternative, and exception relations. For specific eventuality relation types, refer to FIG. 6.

Compared with the prior art, this embodiment of the present disclosure has the following beneficial effects:

1. In this embodiment of the present disclosure, a text mining method based on pure data driving is used. A state is described by a static verb, an activity and an eventuality are described based on an (active) verb, and a sentence is centered on a verb. In this way, the ASER can be effectively mined, and a high-quality and effective KG can be constructed for eventualities.

2. The two-step approach combining the PDTB and the neural network classifier is used to extract the eventuality relations between the eventualities. This not only can reduce the overall complexity, but also can fill in relations among more eventualities in an incrementally and bootstrapping manner, so as to improve coverage and accuracy of relation search.

3. A common syntactic pattern is extracted from the dependency relation graph through text mining to form an eventuality, thereby making eventuality extraction simpler and less complex.

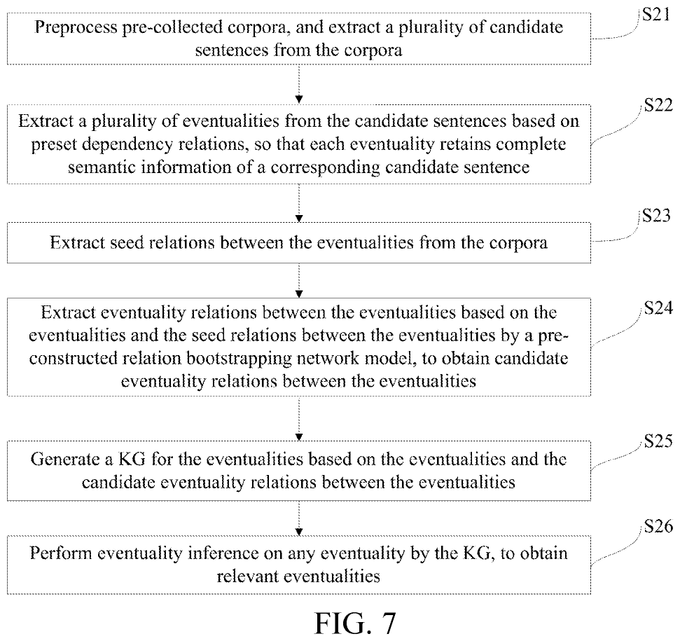

As shown in FIG. 7, a second embodiment of the present disclosure provides an eventuality prediction method. The method is executed by an eventuality prediction device. The eventuality prediction device may be a computing device such as a computer, a mobile phone, a tablet, a laptop or a server. The eventuality prediction method may be integrated with the eventuality prediction device as one functional module, and executed by the eventuality prediction device.

The method specifically includes the following steps.

S21: Preprocess pre-collected corpora, and extract a plurality of candidate sentences from the corpora.

S22: Extract a plurality of eventualities from the candidate sentences based on preset dependency relations, so that each eventuality retains complete semantic information of a corresponding candidate sentence.

S23: Extract seed relations between the eventualities from the corpora.

S24: Extract eventuality relations between the eventualities based on the eventualities and the seed relations between the eventualities by a pre-constructed relation bootstrapping network model, to obtain candidate eventuality relations between the eventualities.

S25: Generate a KG for the eventualities based on the eventualities and the candidate eventuality relations between the eventualities.

S26: Perform eventuality inference on any eventuality by the KG, to obtain relevant eventualities.

This embodiment of the present disclosure applies the KG constructed in the first embodiment. A matched eventuality can be found accurately through probability statistics and inference by a preset eventuality matching scheme and the KG. For example, a sentence “The dog is chasing the cat, suddenly it barks.” is provided. In this sentence, a word that “it” refers to needs to be understood. To resolve this problem, two eventualities “dog is chasing cat” and “it barks” are extracted by performing steps S21 and 22. As the pronoun “it” is not informative in this example, “it” is replaced with “dog” and “cat” separately to generate two pseudo-eventualities. The four eventualities “dog is chasing cat”, “it barks”, “dog barks”, and “cat barks” are used as inputs of the KG, and it is found that “dog barks” appears for 65 times while “cat barks” appears only once. Therefore, it is obtained that “dog barks” is an eventuality, and eventuality prediction is more accurate. For three different levels of eventuality matching schemes (words, skeleton words, and verbs), refer to FIG. 7.

In an optional embodiment, the performing eventuality inference on any eventuality by the KG, to obtain relevant eventualities specifically includes:

performing eventuality retrieval on the eventuality by the KG, to obtain an eventuality corresponding to a maximum eventuality probability as the relevant eventualities.

The eventuality retrieval includes one-hop inference and multi-hop inference. In this embodiment of the present disclosure, an eventuality retrieval process is described by one-hop interference and two-hop inference. The eventuality retrieval is defined as follows: It is assumed that there is an eventuality Eₕ and a relation list L=(R₁, R₂ . . . , Rₖ). A related eventuality Eₜ is found, so that a path containing all relations L from Eₕ to Eₜ in the ASER of the KG can be found.

One-hop inference: For one-hop inference, there is only one edge between the two eventualities. Therefore, it is assumed that the edge is a relation R₁. In this case, a probability of any possible eventuality Eₜ is as follows:

$$P ( {E}_{t} \vert {R}_{1} , {E}_{h} ) = \frac{f ( {E}_{h} , {R}_{1} , {E}_{t} )}{{Σ}_{{E}_{t}^{′} , s . t . , ( {E}_{t} , {R}_{1} ) ∈ ASER} f ( {E}_{h} , {R}_{1} , {E}_{t}^{′} )} \qquad ( 1 )$$

where f(Eₕ, R₁, Eₜ) represents edge strength. If no related eventuality is connected with Eₕ via the edge R₁, P(Eₜ|R₁, Eₕ)=0. Therefore, for any eventuality E′, E′∈E. E represents a set of eventualities E′. Therefore, the related eventuality Eₜ corresponding to a maximum probability can be easily retrieved by sorting probabilities. S represents the number of sentences, and t represents a relation set.

Two-hop inference: It is assumed that two relations between two eventualities are R₁ and R₂ in order. Based on the formula (1), a probability of the eventuality Eₜ under a two-hop setting is as follows:

P(Eₜ|R₁, R₂, Eₕ)=Σ_{E}_{ₘ}_{∈E}_{ₘ}P(Eₘ|R₁, Eₕ)P(Eₜ|R₂, Eₘ) (2)

where Eₘ represents a set of intermediate eventualities Eₘ so that (Eₕ, R₁, Eₘ) and (Eₘ, R₂, Eₜ)∈ASER.

The eventuality retrieval is described below by an example.

An eventuality “I go to the restaurant.” is given. After related eventualities are retrieved from the ASER of the KG, an eventuality having a reason relation with the given eventuality is “I am hungry”, and an eventuality having a succession relation with the given eventuality is “I order food”. In other words, a main reason of the eventuality “ I go to the restaurant” is “I am hungry”, and the eventuality “ I go to the restaurant” occurs before “I order food”. By knowing these relations based on the ASER of the KG, questions such as “Why do you go to the restaurant?” and “What will you do next?” can be answered through inference, and no more contexts are needed. This reduces complexity and improves inference efficiency.

In an optional embodiment, the performing eventuality inference on any eventuality by the KG, to obtain relevant eventualities specifically includes:

performing relation retrieval on the eventuality by the KG, to obtain eventualities with an eventuality probability greater than a preset probability threshold as the relevant eventualities.

The relation retrieval also includes one-hop inference and multi-hop inference. In this embodiment of the present disclosure, an eventuality retrieval process is described by one-hop interference and two-hop inference.

One-hop inference: It is assumed that there are two eventualities Eₕ and Eₜ. Therefore, a probability that there is a relation R from Eₕ to Eₜ is:

$$P ( R \vert {E}_{h} , {E}_{t} ) = \frac{f ( {E}_{h} , R , {E}_{t} )}{{Σ}_{{R}^{′} ∈ {R}_{T}} f ( {E}_{h} , {R}^{′} , {E}_{t} )} \qquad ( 3 )$$

where T represents a type of the relation R, and R_{T} represents a set of relations of the relation type T. T∈T. A most possible relation that can be obtained is:

$${R}_{max} = {argmax}_{{R}^{′} ∈ R} P ( {R}^{′} \vert {E}_{h} , {E}_{t} ) \qquad ( 4 )$$

where P indicates an aforementioned plausibility scoring function in the formula (3), and R represents a relation set. When P(Rₘₐₓ|Eₕ, Eₜ) is greater than 0.5, the KG returns Rₘₐₓ; otherwise, “NULL” is returned.

Two-hop inference: It is assumed that there are two eventualities Eₕ and Eₜ. Therefore, a probability that there is a two-hop connection (R₁, R₂) from Eₕ to Eₜ is:

$$\begin{matrix}P ( {R}_{1} , {R}_{2} \vert {E}_{h} , {E}_{t} ) = {Σ}_{{E}_{m} ∈ {E}_{m}} P ( {R}_{1} , {R}_{2} , {E}_{m} \vert {E}_{h} , {E}_{t} ) \\ = {Σ}_{{E}_{m} ∈ {E}_{m}} P ( {R}_{1} \vert {E}_{h} ) P ( {E}_{m} \vert {R}_{1} , {E}_{h} ) P ( {R}_{2} \vert {E}_{m} , {E}_{t} )\end{matrix} \qquad ( 5 )$$

where P(R|Eₕ) represents a probability of a relation R based on the eventuality Eₕ. A specific formula is as follows:

$$P ( R \vert {E}_{h} ) = \frac{{Σ}_{{E}_{t} , s . t . , ( {E}_{t} , R ) ∈ ASER} f ( {E}_{h} , R , {E}_{t}^{′} )}{{Σ}_{{R}^{′} ∈ {ℛ}_{T}} {Σ}_{{E}_{t} , s . t . , ( {E}_{t} , R ) ∈ ASER} f ( {E}_{h} , {R}^{′} , {E}_{t} )} \qquad ( 6 )$$

A most possible relation pair that can be obtained is:

$$( {R}_{1 , max} , {R}_{2 , max} ) = {argmax}_{{R}_{1}^{′} , {R}_{2}^{′} ∈ ℛ} P ( {E}_{h} , {R}_{1}^{′} , {R}_{2}^{′} , {E}_{t} ) \qquad ( 7 )$$

Similar to one-hop inference, when P(Eₕ, R_{1,max}, R_{2,max}, Eₜ) is greater than 0.5, the KG returns R_{1,max}, R_{2,max}; otherwise, “NULL” is returned.

Compared with the prior art, this embodiment of the present disclosure has the following beneficial effects:

1. Based on the above constructed high-quality and effective KG, an eventuality can be predicted accurately, and a better dialogue response can be generated. The KG can be widely used in the field of man-machine dialogues such as problem resolving and a dialogue system.

2. This embodiment of the present disclosure provides many conditional probabilities to display different semantic meanings to test language understanding problems, thereby making eventuality prediction more accurate.

The KG construction device for eventuality prediction includes at least one processor, such as a CPU, at least one network interface or another user interface, a memory, and at least one communication bus. The communication bus is configured to realize connection and communication between these components. Optionally, the user interface may be a USB interface, another standard interface, or a wired interface. Optionally, the network interface may be a Wi-Fi interface or another wireless interface. The memory may include a high-speed random access memory (RAM), and may also include a non-volatile memory (NVM), such as at least one disk memory. Optionally, the memory may contain at least one storage apparatus far away from the aforementioned processor.

In some implementations, the memory stores the following elements, executable modules or data structures, or their subsets, or their extension sets:

an operating system, containing various system programs for realizing various basic services and processing hardware-based tasks; and

a computer program.

Specifically, the processor is configured to invoke the program stored in the memory, to execute the KG construction method for eventuality prediction described in the above embodiment, for example, step S11 shown in FIG. 1. Alternatively, the processor executes the computer program to implement functions of the modules/units in the above-mentioned apparatus embodiments.

For example, the computer program may be divided into one or more modules/units. The one or more modules/units are stored in the memory and executed by the processor to complete the present disclosure. The one or more modules/units may be a series of computer program instruction segments capable of completing specific functions, and the instruction segments are used for describing an execution process of the computer program in the KG construction device for eventuality prediction.

The KG construction device for eventuality prediction may be a computing device such as a desktop computer, a laptop, a palmtop computer, or a cloud server. The KG construction device for eventuality prediction may include, but not limited to, the processor and the memory. Those skilled in the art can understand that the schematic diagram shows only an example of the KG construction device for eventuality prediction, does not constitute a limitation to the KG construction device for eventuality prediction, and may include more or less components than those shown in the figure, a combination of some components, or different components.

The processor may be a Central Processing Unit (CPU), and may also be another general-purpose processor, a Digital Signal Processor (DSP), an Application Specific Integrated Circuit (ASIC), a Field-Programmable Gate Array (FPGA) or another programmable logic device, a discrete gate, a transistor logic device, a discrete hardware component, or the like. The general-purpose processor may be a microprocessor, or any conventional processor. The processor is a control center of the KG construction device for eventuality prediction, and connects to, by various interfaces and lines, various parts of the whole KG construction device for eventuality prediction.

The memory may be configured to store the computer program and/or modules. The processor implements, by running or executing the computer program and/or modules stored in the memory and invoking data stored in the memory, various functions of the KG construction device for eventuality prediction. The memory may mainly include a program storage area and a data storage area. The program storage area may store an operating system, an application program required by at least one function (such as a sound playing function and an image playing function), and the like. The data storage area may store data (such as audio data and an address book) created based on use of a mobile phone, and the like. In addition, the memory may include a high-speed random access memory, and may further include a non-volatile memory, such as a hard disk, an internal storage, a plug-in hard disk, a Smart Media Card (SMC), a Secure Digital (SD) card, a Flash Card, at least one magnetic disk storage device, a flash memory device, or another volatile solid-state storage device.

A module or unit integrated in the KG construction device for eventuality prediction, if implemented in a form of a software functional unit and sold or used as a stand-alone product, may be stored in a computer-readable storage medium. Based on such an understanding, all or some of processes for implementing the method in the foregoing embodiments can be completed by a computer program instructing relevant hardware. The computer program may be stored in a computer-readable storage medium. The computer program is executed by a processor to perform steps of the foregoing method embodiments. The computer program includes computer program code, and the computer program code may be in a form of source code, a form of object code, an executable file or some intermediate forms, and the like. The computer-readable medium may include: any physical entity or apparatus capable of carrying computer program code, a recording medium, a USB disk, a mobile hard disk drive, a magnetic disk, an optical disc, a computer memory, a Read-Only Memory (ROM), a Random Access Memory (RAM), an electrical carrier signal, a telecommunications signal, a software distribution medium, and the like. It should be noted that, the content contained in the computer-readable medium may be added or deleted properly according to the legislation and the patent practice in the jurisdiction. For example, in some jurisdictions, depending on the legislation and the patent practice, the computer-readable medium may not include the electrical carrier signal or the telecommunications signal.

The descriptions above are preferred implementations of the present disclosure. It should be noted that for a person of ordinary skill in the art, various improvements and modifications can be made without departing from the principles of the present disclosure. These improvements and modifications should also be regarded as falling into the protection scope of the present disclosure.

1. A knowledge graph (KG) construction method for eventuality prediction, comprising:
preprocessing pre-collected corpora, and extracting a plurality of candidate sentences from the corpora;
extracting a plurality of eventualities from the candidate sentences based on preset dependency relations, so that each eventuality retains complete semantic information of a corresponding candidate sentence;
extracting seed relations between the eventualities from the corpora;
extracting eventuality relations between the eventualities based on the eventualities and the seed relations between the eventualities by a pre-constructed relation bootstrapping network model, to obtain candidate eventuality relations between the eventualities; and
generating a KG for the eventualities based on the eventualities and the candidate eventuality relations between the eventualities.

2. The KG construction method for eventuality prediction according to claim 1, wherein the extracting a plurality of eventualities from the candidate sentences based on preset dependency relations, so that each eventuality retains complete semantic information of a corresponding candidate sentence specifically comprises:
extracting verbs from the candidate sentences;
matching, by the preset dependency relations, an eventuality pattern corresponding to a candidate sentence in which each verb is located; and
extracting, from the candidate sentence and based on the eventuality pattern corresponding to the candidate sentence in which the verb is located, an eventuality centered on the verb.

3. The KG construction method for eventuality prediction according to claim 2, wherein the preset dependency relations comprise a plurality of eventuality patterns, and each pattern comprises one or more of connections between nouns, prepositions, adjectives, verbs and edges.

4. The KG construction method for eventuality prediction according to claim 1, wherein the preprocessing pre-collected corpora, and extracting a plurality of candidate sentences from the corpora specifically comprises:
performing natural language processing (NLP) on the corpora, and extracting the plurality of candidate sentences.

5. The KG construction method for eventuality prediction according to claim 3, wherein the matching, by the preset dependency relations, an eventuality pattern corresponding to a candidate sentence in which each verb is located specifically comprises:
constructing a one-to-one corresponding code for each eventuality pattern in the preset dependency relations; and
performing, based on the code, syntactic analysis on the candidate sentence in which the verb is located, to obtain the eventuality pattern corresponding to the candidate sentence in which the verb is located.

6. The KG construction method for eventuality prediction according to claim 1, wherein the extracting seed relations between the eventualities from the corpora specifically comprises:
annotating a connective in the corpora by a relation defined in a Penn Discourse Tree Bank (PDTB); and
based on an annotated connective and the eventualities, taking global statistics on annotated corpora, and extracting the seed relationship between the eventualities.

7. The KG construction method for eventuality prediction according to claim 1, wherein the extracting eventuality relations between the eventualities based on the eventualities and the seed relations between the eventualities by a pre-constructed relation bootstrapping network model, to obtain candidate eventuality relations between the eventualities specifically comprises:
initializing seed relations N and their corresponding two eventualities into an instance X;
training a pre-constructed neural network classifier by the instance X, to obtain the relation bootstrapping network model that automatically marks a relation, and an eventuality relation between the two eventualities; and
taking global statistics on the eventuality relation, adding an eventuality relation with confidence greater than a preset threshold to the instance X, and inputting an obtained instance X into the relation bootstrapping network model again for training to obtain a candidate eventuality relation between the two eventualities.

8. An eventuality prediction method, comprising:
preprocessing pre-collected corpora, and extracting a plurality of candidate sentences from the corpora;
extracting a plurality of eventualities from the candidate sentences based on preset dependency relations, so that each eventuality retains complete semantic information of a corresponding candidate sentence;
extracting seed relations between the eventualities from the corpora;
extracting eventuality relations between the eventualities based on the eventualities and the seed relations between the eventualities by a pre-constructed relation bootstrapping network model, to obtain candidate eventuality relations between the eventualities;
generating a KG for the eventualities based on the eventualities and the candidate eventuality relations between the eventualities; and
performing eventuality inference on any eventuality by the KG, to obtain relevant eventualities.

9. The eventuality prediction method according to claim 8, wherein the performing eventuality inference on any eventuality by the KG, to obtain relevant eventualities specifically comprises:
performing eventuality retrieval on the eventuality by the KG, to obtain an eventuality corresponding to a maximum eventuality probability as the relevant eventualities.

10. The eventuality prediction method according to claim 8, wherein the performing eventuality inference on any eventuality by the KG, to obtain relevant eventualities specifically comprises:
performing relation retrieval on the eventuality by the KG, to obtain eventualities with an eventuality probability greater than a preset probability threshold as the relevant eventualities.
